(19) United States
(12) Patent Application Publication
(10) Pub. No.: US 2009/0324857 A1
(43) Pub. Date: Dec. 31, 2009

(54) INK JET RECORDING MEDIUM

(75) Inventors: Teruaki Okuda, Tokyo (JP); Yoshiyuki Nagase, Kawasaki-shi (JP); Kensuke Tone, Kawasaki-shi (JP); Takeshi Oota, Kawasaki-shi (JP); Junichi Nagayama, Tokyo (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/478,420

(22) Filed: Jun. 4, 2009

(30) Foreign Application Priority Data
Jun. 25, 2008 (JP) 2008-165696

(51) Int. Cl. B41M 5/40

(52) U.S. Cl. 428/32.35

(57) ABSTRACT

Provided is an ink jet recording medium including a substrate a porous layer containing one of a dry-process silica and an alumina hydrate and a silica layer containing spherical colloidal silica particles having a particle size of 105 nm or more and 200 nm or less. The porous layer and the silica layer are formed on the substrate in this order. The porous layer is covered by the spherical colloidal silica particles at a coverage of 40% or more and 75% or less.

### BACKGROUND OF THE INVENTION

1. Field of the Invention

The present invention relates to an ink jet recording medium, which may be suitably employed in ink jet recording that uses an aqueous pigment ink and an aqueous dye ink.

2. Description of the Related Art

There have been known ink jet recording media having various structures for use in image formation by ink jet recording. Today, those ink jet recording media are widely used for outputs of electronic image data in computers and networks and outputs of image data taken into a digital camera, a digital video camera, or a scanner. Along with enlarged application ranges of a recording apparatus (printer) employing the ink jet recording, rapid improvements have been made on recording characteristics such as high-speed recording, high-definition recording, and full-color recording. Further, as the result of improvements in the recording apparatus and a recording method, a wider variety of or further advanced demands with respect to the performance of the ink jet recording medium are being arisen.

In order to achieve the above demands, there have conventionally been proposed a wide variety of structures of an ink jet recording medium. In each of Japanese Patent Application Laid-Open No. H02-276670 (Patent Document 1) and Japanese Patent Application Laid-Open No. S60-204390 (Patent Document 2), there is proposed an ink jet recording medium using, in order to improve ink absorbency and paper sheet surface glossiness, a dry-process silica or an alumina hydrate each formed of fine particles of the nanometer order. An object of those ink jet recording media is to achieve high-quality image output of a photograph or the like.

Further, in each of Japanese Patent Application Laid-Open No. H07-076162 (Patent Document 3) and Japanese Patent Application Laid-Open No. 2007-076228 (Patent Document 4), there is proposed an ink jet recording medium provided with a silica layer containing spherical silica as a main component on an ink receiving layer in order to obtain higher glossiness and to improve scratch resistance.

Still further, in each of Japanese Patent Application Laid-Open No. H10-166715 (Patent Document 5) and Japanese Patent Application Laid-Open No. 2000-238411 (Patent Document 6), there is proposed an ink jet recording medium having, in order to improve ink absorbency of silica layer, a silica layer using non-spherical colloidal silica.

### SUMMARY OF THE INVENTION

The ink jet recording media described in Patent Documents 1 to 6 have an aim to improve characteristics of ink absorbency, resolution, image density, and glossiness. However, even in the case of using those ink jet recording media, there occur various problems at the time of high speed printing which has been required in recent years.

For example, the ink jet recording media described in Patent Documents 1 and 2, which contain a dry-process silica or a alumina hydrate and are formed of one layer, can have excellent image quality. On the contrary, the surfaces of those ink jet recording media are easily scratched, and hence, a conveyance scratch on the surface easily occurs depending on the conveyance method of printers. Further, the glossiness of those ink jet recording media is excellent when compared with that of an ink jet recording medium containing silica having a particle size of the micron order and being produced by a wet method. However, there have been still some cases where the glossiness is not practically sufficient.

Further, the ink jet recording media described in Patent Documents 3 and 4, which are provided with a layer containing colloidal silica as a main component on an ink receiving layer formed of fine particles of the nanometer order, can have excellent glossiness. In those ink jet recording media, however, the colloidal silica layer on the surface layer inhibits the ink absorption so that the ink absorbency thereof is poor, and there have been some cases where ink bleeding occurs at the time of high speed printing and the ink jet recording media are not suitable for the high speed printing.

Accordingly, the deterioration of the ink absorbency can be alleviated to some extent by using non-spherical colloidal silica instead of generally-used spherical colloidal silica. At present, however, it is still far from achieving the ink absorbency which is sufficiently adaptable to high speed printing of a printer main body.

In addition, a printer using a pigment ink has recently become widely used. The pigment ink is different from a conventional dye ink and contains solid components such as an ink pigment and a polymer for dispersing the ink pigment, and hence, the ink absorbency required for the ink jet recording medium has been further advanced. Therefore, when printing is performed with the pigment ink on the ink jet recording medium using the non-spherical colloidal silica as described in each of Patent Documents 5 and 6, there have been some cases where sufficient ink absorbency cannot be achieved.

The present invention has been made in view of solving the above-mentioned problems, and the present invention has realized both high image quality and ink absorbency, which are required for an ink jet recording medium along with the recent development of an ink jet recording apparatus. Thus, an object of the present invention is to provide an ink jet recording medium which has high glossiness and is excellent for high speed printing with an aqueous pigment ink and an aqueous dye ink, which requires high absorbency of the ink jet recording medium, and is excellent in surface scratch resistance.

One embodiment of the present invention is an ink jet recording medium, including a substrate; a porous layer containing one of a dry-process silica and an alumina hydrate; and a silica layer containing spherical colloidal silica particles having a particle size of 105 nm or more and 200 nm or less, the porous layer and the silica layer being formed on the substrate in the stated order, in which the porous layer is covered by the spherical colloidal silica particles at a coverage of 40% or more and 75% or less.

The ink jet recording medium of the present invention can realize both high image quality and ink absorbency, which are required for an ink jet recording medium, and can also be adaptable to high speed printing with an aqueous pigment ink, which requires high absorbency of the ink jet recording medium, and to printing with an aqueous dye ink. Further, there can be provided an ink jet recording medium which has high glossiness and is excellent in surface scratch resistance.

Further features of the present invention will become apparent from the following description of exemplary embodiments with reference to the attached drawings.

### BRIEF DESCRIPTION OF THE DRAWINGS

FIG. 1 is a plan view illustrating an example of an ink jet recording medium, which is viewed from a recording surface side.

FIG. 2 is a cross-sectional view illustrating an example of an ink jet recording medium.

FIG. 3 is an enlarged view illustrating a cross section of an example of an ink jet recording medium.

FIG. 4 is a cross-sectional view illustrating an example of an ink jet recording medium after printing.

FIG. 5 is a cross-sectional view illustrating an example of an ink jet recording medium after printing.

FIG. 6 is a cross-sectional view illustrating an example of an ink jet recording medium after printing.

### DESCRIPTION OF THE EMBODIMENTS

Hereinafter, the present invention is described in detail.

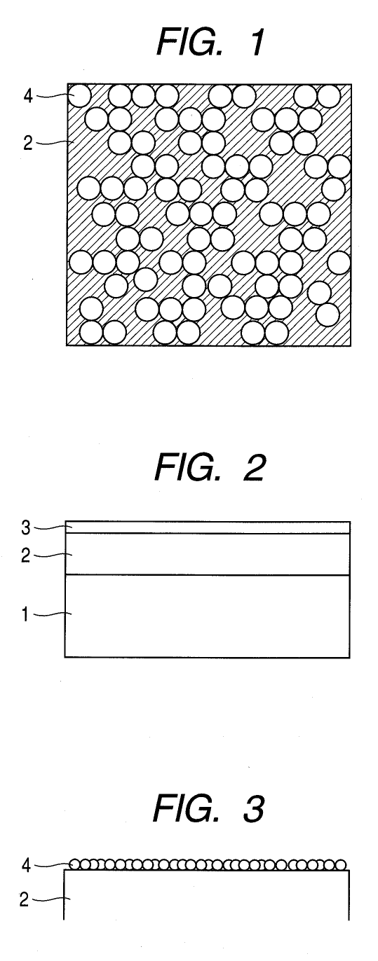

FIGS. 1 to 3 illustrate an example of an ink jet recording medium of the present invention. FIG. 2 is a cross-sectional view illustrating the ink jet recording medium. As illustrated in FIG. 2, the ink jet recording medium of the present invention is provided with, on a substrate 1, a porous layer 2 and a silica layer 3 in the stated order.

FIG. 3 is a view in which the cross-section of the ink jet recording medium illustrated in FIG. 1 is enlarged. In FIG. 3, a silica layer formed of spherical colloidal silica particles 4 is provided on the porous layer 2. FIG. 1 is an enlarged plane view of the ink jet recording medium viewed from a side of the silica layer (upper part of the recording medium). As illustrated in FIG. 1, the ink jet recording medium is provided with a silica layer on top of the porous layer 2, and the silica layer contains the spherical colloidal silica particles 4. Further, the spherical colloidal silica particles 4 contained in the silica layer do not completely cover the porous layer 2, and thus, some parts of the porous layer 2 are exposed.

The silica layer 3 contains spherical colloidal silica particles 4 having a particle size of 105 nm or more and 200 nm or less. Further, the porous layer is covered by the spherical colloidal silica particles at a coverage of 40% or more and 75% or less. Note that the coverage is preferably 60% or more and 75% or less.

(Silica Layer)

The following items (1) to (5) each describe an effect obtained by using, in a silica layer, colloidal silica particles each being spherical and having a particle size of 105 nm or more and 200 nm or less.

(1) In the present invention, large colloidal silica particles each being spherical and having a particle size of 105 nm or more and 200 nm or less are used, and hence, a void is easily formed between the spherical colloidal silica particles. Consequently, in the case of performing printing with an aqueous dye ink on an ink jet recording medium, an ink component easily passes through the silica layer, and hence, an ink jet recording medium having excellent ink absorbency can be obtained. As a result, ink bleeding in the case of high speed printing is prevented from occurring and an excellent image quality can be achieved.

(2) Further, in the case of performing printing with an aqueous dye ink on an ink jet recording medium, the occurrence of haze is prevented and image density can be enhanced. The reason therefor can be presumed as follows. That is, when the printing is performed with the aqueous dye ink, a dye component which has a color development function is adsorbed to a dry-process silica or an alumina hydrate having a particle size of the nanometer order contained in the porous layer, and then the color of the dye component is developed. At that time, the spherical colloidal silica particles without ink absorbing ability have particle sizes within the above range, thereby diminishing scattering factors. Thus, the color of the dye component contained in the porous layer is effectively developed.

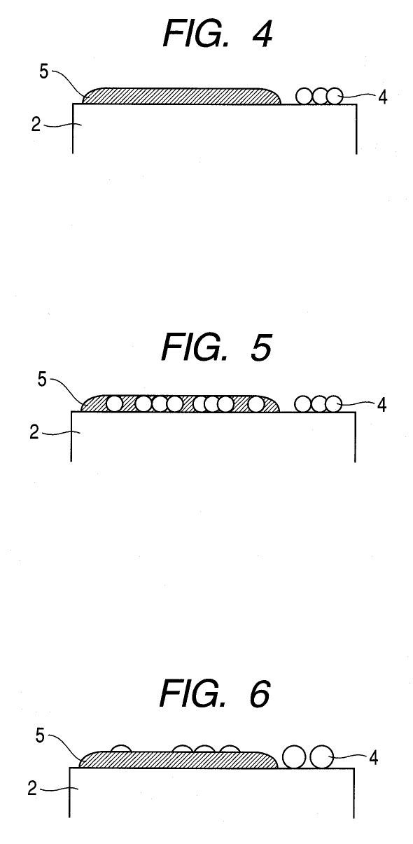

(3) Regarding an aqueous pigment ink, the particle size of a pigment component having a color development function is larger than the size of a void (of the micro-nanometer order) in a porous layer containing a dry-process silica or an alumina hydrate. Therefore, in the case of performing printing with the aqueous pigment ink on the ink jet recording medium of the present invention, pigment particles stay in the silica layer. Here, when the printing is performed with the aqueous pigment ink on the ink jet recording medium, the height of one dot of ink, which is formed of one droplet of the aqueous pigment ink, is about 200 nm. Accordingly, in the case where the spherical colloidal silica particles have a particle size of 200 nm less, a pigment ink 5 which is used for printing covers the spherical colloidal silica particles 4 as illustrated in FIG. 4. Note that FIG. 5 is a view illustrating, in a clearly understandable way, the state of the spherical colloidal silica particles contained in the droplet of the pigment ink illustrated in FIG. 4. However, in the case where the spherical colloidal silica particles have a particle size of larger than 200 nm, the pigment ink cannot cover the spherical colloidal silica particles as illustrated in FIG. 6. As a result, the spherical colloidal silica particles are protruded from a pigment ink layer formed after the printing and cause scattering. Thus, undertrapping occurs in the image after the printing, which brings about a decrease in image density.

(4) The ink jet recording medium can have an excellent glossiness. The reason therefor can be presumed as follows. That is, because the silica layer substantially has a single-layer structure, the silica layer, in general, is in the condition of easily being affected by the surface irregularities of the porous layer. However, when the spherical colloidal silica particles have particle sizes within the above range, it becomes less likely that the silica layer is affected by the surface irregularities of the porous layer. As a result, even if there are irregularities on the surface of the porous layer, the surface of the silica layer is made flat and smooth by arranging the spherical colloidal silica particles so as to cancel the surface irregularities of the porous layer.

(5) In the case where moniliform colloidal silica particles, which are different from the spherical colloidal silica particles, are used in the silica layer, the moniliform colloidal silica particles have a three-dimensional structure. Consequently, the moniliform colloidal silica particles are stacked sterically, and hence, the silica layer cannot have a single-layer structure formed of colloidal silica particles. As a result, the thickness of the silica layer increases, which inhibits the ink absorption to the porous layer. Further, the ink jet recording medium using the moniliform colloidal silica particles in the silica layer cannot be adaptable to, by additionally improving ink absorbency of the ink jet recording medium, high speed printing with an aqueous pigment ink which requires high absorbency.

In producing the ink jet recording medium of the present invention, it is preferred to use spherical colloidal silica particles which are in colloidal form and are uniformly dispersed in a dispersion medium. In general, those spherical colloidal silica particles are in the form of a dispersion liquid in which ultrafine particles of silicic acid anhydride (silica) are stably dispersed in water.

Note that the particle size of the spherical colloidal silica particle is preferably 105 nm or more and 130 nm or less.

The following items (1) to (3) each describe a synergistic effect exhibited by the porous layer being covered by the spherical colloidal silica particles at a coverage of 40% or more and 75% or less in addition to the use of, in a silica layer, the colloidal silica particles having a particle size of 105 nm or more and 200 nm or less.

(1) When ideal spheres are placed so as to cover an ideal flat and smooth surface and the surface is viewed downwardly from above, the coverage thereof is theoretically (π/4)×100≈79%. Accordingly, in the case where the coverage is larger than 79%, it means that two or more overlapped spheres are present on a flat surface and are not in the form of a single layer. Consequently, the coverage is set to 75% to thereby provide a silica layer having a nearly single layer state (coverage of 75%) in which the spherical colloidal silica particles are close-packed. Further, the coverage is set to 45% or more to thereby provide a silica layer in which the number of spherical colloidal silica particles is smaller and the porous layer is more exposed compared with the state at the coverage of 75%. Accordingly, when the thickness of the silica layer becomes larger, the inhibition of the ink absorption to the porous layer can be suppressed even in the case where the particle size of the colloidal silica particle is large. As a result, the ink absorbency of the ink jet recording medium is additionally improved, and the ink jet recording medium can be adaptable to high speed printing with an aqueous pigment ink which requires high absorbency.

(2) In the case where the coverage by the spherical colloidal silica particles is less than 40%, the glossiness of the ink jet recording medium decreases. The reason therefor is that large irregularities occur on the surface of the ink jet recording medium by a part where spherical colloidal silica particles having a large particle size are present and a part where spherical colloidal silica particles having a large particle size are not present.

(3) In the case where the coverage by the spherical colloidal silica particles exceeds 75%, a large amount of spherical colloidal silica particles having a large particle size are present in the silica layer. Consequently, in the case where multiple ink jet recording media in the form of cut sheets are set in a cassette of a recording apparatus and are fed and conveyed from the cassette, the spherical colloidal silica particles on one recording medium cause a scratch or the like on another recording medium. As a result, image quality is deteriorated.

The absolute dry amount of the spherical colloidal silica particles contained in the silica layer is preferably 100 mg/m² or more and 200 mg/m² or less. The absolute dry amount of the spherical colloidal silica particles is set within the above range so that the coverage can be effectively controlled to be in the range of 40% or more and 75% or less.

Note that, in the present invention, the measurement of the coverage of the porous layer by the spherical colloidal silica particles is determined by photographing a region of 26 μm×20 μm at 50,000-fold magnification by electron microscope observation; taking the image of the region; determining the number of pixels occupied by the spherical colloidal silica particles included in the image; and dividing the number of pixels by the entire number of pixels.

The spherical colloidal silica particles of the present invention are neither in a long, slender shape in which small silica particles are bonded like a chain nor in a three-dimensional network structure. Although for production reasons, it is difficult to make colloidal silica particles of a perfect sphere, the colloidal silica particles are substantially of a pseudosphere. When the colloidal silica particles are observed with an electron microscope photograph, the shape of the particle (which is ellipse) viewed from the surface has a ratio of a long axis to a short axis (long-axis/short-axis) in the range of 1.0 to 1.5.

A coating method for the silica layer is not particularly limited as long as the effects of the present invention are not adversely affected. For example, in the case of using a curtain coating or the like which is capable of simultaneously coating multiple layers, a coating liquid for a silica layer and a coating liquid for a porous layer can be applied simultaneously. In this case, a binder may not be added to the coating liquid for a silica layer.

In addition to the above coating method, other methods of applying a coating liquid for a silica layer can be performed by using general coating devices including various devices such as a blade coater, a roll coater, an air-knife coater, a bar coater, a gate roll coater, a curtain coater, a die coater, a gravure coater, a flexogravure coater, and a size press, in on-machine or off-machine. It is preferred to appropriately select the coating amount of the coating liquid for a silica layer such that the absolute dry amount of the spherical colloidal silica particles after drying is in the range of 100 mg/m² or more and 200 g/m² or less.

A binder may be added, as required, to the coating liquid for a silica layer. As the binder, for example, polyvinyl alcohol, a modified product thereof, polyvinylpyrrolidone, vinyl acetate, oxidized starch, etherified starch, casein, gelatin, soybean protein, carboxymethyl cellulose, SB latex, NB latex, acrylic latex, ethylenevinyl acetate-based latex, polyurethane, and unsaturated polyester can be used.

Those binders may be used alone, or in a mixture of two or more kinds thereof. The content thereof is preferably as small as possible, taking into consideration the film forming property and film strength of the porous layer. The reason therefor is that those hydrophilic resins are apt to swell with a solvent component of an ink and inhibit the pigment ink absorbency. The content of the binder in the porous layer is, with respect to the total solid content mass of the porous layer, preferably 30 mass % or less and more preferably 10 mass % or less.

Further, typically, the silica layer is formed only of the spherical colloidal silica particles. However, if required, there may be appropriately added to the silica layer, in such a range that the effect of the present invention is not adversely affected, at least one material selected from the group consisting of a water resistant additive, a pigment dispersant, a thickener, an anti-foaming agent, a foam inhibitor, a release agent, a foaming agent, a coloring dye, a coloring pigment, a fluorescent dye, an ultraviolet absorber, an antioxidant, an antiseptic agent, a surfactant, and a wet paper strengthening agent. Note that even in the case of adding the above additives to the silica layer, the silica layer is mainly formed of the spherical colloidal silica particles. In this case, the content of the spherical colloidal silica particles in the silica layer is preferably 50 mass % or more and 100 mass % or less and more preferably 70 mass % or more and 98 mass % or less.

In the present invention, the particle size of the spherical colloidal silica particle and the coverage of the porous layer by the spherical colloidal silica particles are controlled as described above, and hence, controlling the particle size and controlling the coverage act synergistically, whereby both high image quality and ink absorbency, which are required for an ink jet recording medium, can be realized. Further, there can be provided an ink jet recording medium which has high glossiness and is excellent in surface scratch resistance.

(Porous Layer)

The porous layer of the present invention contains a dry-process silica or an alumina hydrate. The dry-process silica generally refers to silica produced by burning silicon tetrachloride, hydrogen, and oxygen, and may also be referred to as a gas-phase method silica.

The dry-process silica has a BET specific surface area of preferably 50 to 200 m²/g and more preferably 100 to 200 m²/g.

Further, as the alumina hydrate, an alumina hydrate represented by the following general formula (X) can be suitably used.

Al₂O₃₋ₙ(OH)₂ₙ.mH₂O (X)

(In the formula, n represents one of 0, 1, 2, and 3, and m represents 0 to 10 or preferably a value in the range of 0 to 5, provided that m and n do not represent 0 at the same time. In many cases, mH₂O represents a detachable aqueous phase which does not participate in the formation of a crystal lattice, and thus, m may take an integer or a value other than integers. When this kind of material is heated, m may reach a value of 0.)

The alumina hydrate preferably has a boehmite structure, and the BET specific surface area thereof is preferably 100 to 200 m²/g and more preferably 150 to 180 m²/g. When the BET specific surface areas of the dry-process silica and the alumina hydrate are in the above ranges, secondary particles do not become large, and hence, the spherical colloidal silica particles constituting the silica layer do not fall into the porous layer. As a result, a stable, single-layered silica layer can be provided on the porous layer. Further, the ink jet recording medium has excellent ink absorbency for absorbing ink solvent components and can sufficiently be adaptable to high speed printing.

A binder may be added to the porous layer, if required. Examples of the binder include polyvinyl alcohol and a modified product thereof, polyvinylpyrrolidone, vinyl acetate, oxidized starch, esterified starch, casein, gelatin, soybean protein, carboxymethyl cellulose, SB latex, NB latex, acrylic latex, ethylenevinyl acetate-based latex, polyurethane, and unsaturated polyester. Those binders may be used alone, or in a mixture of two or more kinds thereof. The content thereof is preferably as small as possible, taking into consideration film forming property and film strength of the porous layer. The reason therefor is that those hydrophilic resins are apt to swell with a solvent component of an ink and inhibit the pigment ink absorbency. The content of the binder in the porous layer is, with respect to the total solid content mass of the porous layer, preferably 30 mass % or less and more preferably 10 mass % or less.

The polyvinyl alcohol is preferably used as the binder, and in the case of using a mixture of two or more kinds of binders, it is preferred to use at least polyvinyl alcohol. The polyvinyl alcohol can be obtained by neutralizing polyvinyl acetate with alkali, and subjecting the resultant to a saponification reaction involving substituting an acetate group with a hydroxyl group. In the polyvinyl alcohol, characteristics such as film strength, crystallizability, water solubility, and viscosity differ depending on the polymerization degree (molecular weight) and the saponification degree thereof.

In the present invention, it is preferred to use a polyvinyl alcohol having a saponification degree of 90 mol % or more. This makes the beading property of a pigment ink better. The reason therefor can be presumed as follows. That is, a polyvinyl alcohol having high saponification degree is known to easily form a film having high crystallizability. Accordingly, the higher the crystallizability is, that is, the higher the saponification degree of the polyvinyl alcohol is, the lower the swelling property thereof with respect to water is, and hence, the permeability of a solvent component to the inner part of the porous layer in printing with a pigment ink can be further enhanced. As a result, the beading property seems to become satisfactory. Further, the polymerization degree of the polyvinyl alcohol is preferably 1,500 or more from the viewpoint of the film strength of the porous layer.

Further, as the binder, there can be used a binder which can impart a crosslinking structure to the porous layer. The crosslinking structure can be formed in the porous layer by using a binder and a crosslinking agent in combination or by using a binder having crosslinking property. Here, the crosslinking agent refers to a monomer or an oligomer (middle molecular weight component) each having a functional group (reactive group) which may form a covalent bond or a coordination bond by heating or the like. For example, as an inorganic crosslinking agent, there are exemplified a metal oxide of boric acid or sodium borate, and a salt thereof. As an organic crosslinking agent, there are given an isocyanate-based compound, an epoxy-based compound, an N-methylol-based compound, a carbodiimide-based compound, a triazine-based compound, an aldehyde-based compound, a vinylsulfone-based compound, an acryloyl-based compound, an ethyleneimine-based compound, and a siloxane-based compound. As a binder having crosslinking property which contains a reactive functional group in the polymer, there are exemplified a water-soluble acrylic resin having a methylol group, an epoxy group, or a silanol group, and a polyvinyl alcohol.

An advantage obtained by providing the crosslinking property to the binder contained in the porous layer as described above is that the film strength of the binder increases so that the content of the binder in the porous layer can be decreased. As a result, inhibition of ink absorption due to the swelling of the binder by a solvent component can be suppressed on ink absorption, and a porous layer which is more suitable for ink absorption can be formed.

For practical use as an ink jet recording medium, the porous layer preferably contains an ionic resin. The phrase “for practical use” means that the ink jet recording medium can be practically durable in terms of the color developability and the water resistance of a printed image for which printing with an ink is performed on the ink jet recording medium of the present invention. In general, an ink for ink jet recording is anionic. Consequently, a cationic resin, which has an opposite ionicity to that of the ink, is preferably contained in the porous layer.

Examples of the cationic resin include acrylic resins having secondary to quaternary amine groups and obtained by copolymerizing cationic acrylic monomers having an amino group and converting the resultant into a neutralized salt, polyallylamine-based polymer and neutralized salts thereof, pollydiallylamine-based polymer and neutralized salts thereof, polyamine sulfone, polyvinyl amine, polyethylene imine, a polyamide-epichlorohydrin resin, polyvinyl pyrrolidone, polyvinyl pyridium halide, and a polyvinyl imidazole resin.

Further, as an anionic resin, there are exemplified a neutralized salt of an acrylic resin obtained by copolymerizing acrylic monomers having a carboxy group such as (meth)acrylic acid, a neutralized salt of a polyester resin having a carboxy group or a sulfonic acid group, and various anionic dispersants.

The addition amount of those ionic resins can be appropriately selected by taking into consideration the characteristics such as adhesiveness of the image to the porous layer, color developability, and beading property. Note that, when a large amount of those ionic resins are contained in the porous layer, the beading property generally lowers and there is a case where the image deteriorates, and hence, the content in the porous layer is preferably 20 mass % or less.

In addition, there may be appropriately added to the porous layer of the present invention, in such a range that the effects of the present invention are not adversely affected, at least one material selected from the group consisting of a pigment dispersant, a thickener, an anti-foaming agent, a foam inhibitor, a release agent, a foaming agent, a coloring dye, a coloring pigment, a fluorescent dye, an ultraviolet absorber, an antioxidant, an antiseptic agent, a water resistant additive, a surfactant, and a wet paper strengthening agent.

The coating amount of the porous layer is preferably appropriately selected from such layer thicknesses that the coating weights after drying per unit area are in the range of 10 g/m² or more and 40 g/m² or less.

In the present invention, the coating liquid for a porous layer can be used in general coating devices such as a blade coater, a roll coater, an air-knife coater, a bar coater, a gate roll coater, a curtain coater, a die coater, a gravure coater, a flexogravure coater, and a size press, in on-machine or off-machine.

(Substrate)

As a substrate to be used in the present invention, conventionally known various members can be used. Specific examples thereof include various paper such as paper subjected to moderate sizing, unsized paper, and RC paper using a polyethylene film or the like; and a thermoplastic film. In the case of using the thermoplastic film, examples thereof include polyester such as polyethylene terephthalate, polycarbonate, polystyrene, polyvinylchloride, polymethylmethacrylate, and cellulose acetate. In order to obtain a photograph-like image, the substrate is preferably white and high in concealing property, and hence, there can be used a sheet which is subjected to opacification by filling it with a pigment such as an alumina hydrate or titanium white or by finely foaming the sheet. In the present invention, the porous layer and the silica layer are provided on the substrate.

### EXAMPLES

Hereinafter, the present invention is described in detail by way of examples and comparative examples, but the present invention is not limited thereto.

The particle size of the colloidal silica particle was measured by a laser scattering/diffraction particle size analyzer LS230 manufactured by Beckman Coulter Co., after diluting and stirring a colloidal silica dispersion liquid.

In the present invention, the measurement value of the particle size of the colloidal silica obtained from the above measurement corresponds with a measurement value of a particle size obtained by observing with an electron microscope the surface of an ink jet recording medium produced by using the dispersion liquid of the colloidal silica.

The particles contained in the colloidal silica dispersion liquid are separated from each other, and the particle size of each of the particles is measured by the above method. Accordingly, the measurement value is the same as in the case of measuring, by electron microscope observation, each of the colloidal silica particles which are contained in a coating liquid and are provided on the outermost surface of the recording medium.

The measurement of the coverage of the porous layer by the spherical colloidal silica particles was determined by photographing a region of 26 μm×20 μm at 50,000-fold magnification by electron microscope observation; taking the image of the region; determining the number of pixels occupied by the spherical colloidal silica particles in the images; and dividing the number of pixels by the entire number of pixels.

(Production of Coating Liquid 1 for Silica Layer)

First, a dispersion liquid of spherical colloidal silica particles (FUSO CHEMICAL CO., LTD., PL-7; average particle size of 120 nm through particle size measurement by laser scattering; solid content mass of 20 mass %), polyvinyl alcohol (JAPAN VAM & POVAL CO., LTD., JM-26) were prepared. Next, the dispersion liquid of spherical colloidal silica particles and an 8 mass % aqueous solution of polyvinyl alcohol were mixed in such a manner that the mixture had a solid content mass ratio of silica to polyvinyl alcohol of 100:10, and the mixture was stirred. After that, the resultant was diluted and stirred so as to be a 5 mass % liquid.

(Production of Coating Liquid 2 for Silica Layer)

First, a dispersion liquid of spherical colloidal silica particles (Nissan Chemical Industries, Ltd., MP-2040; average particle size of 200 nm through particle size measurement by laser scattering; solid content mass of 40 mass %), polyvinyl alcohol (JAPAN VAM & POVAL CO., LTD., JM-26) were prepared. Next, the dispersion liquid of spherical colloidal silica particles and an 8 mass % aqueous solution of polyvinyl alcohol were mixed in such a manner that the mixture had a solid content mass ratio of silica to polyvinyl alcohol of 100:10, and the mixture was stirred. After that, the resultant was diluted and stirred so as to be a 5 mass % liquid.

(Production of Coating Liquid 3 for Silica Layer)

First, a dispersion liquid of spherical colloidal silica particles (Nissan Chemical Industries, Ltd., MP-1040; average particle size of 100 nm through particle size measurement by laser scattering; solid content mass of 40 mass %), polyvinyl alcohol (JAPAN VAM & POVAL CO., LTD., JM-26) were prepared. Next, the dispersion liquid of spherical colloidal silica particles and an 8 mass % aqueous solution of polyvinyl alcohol were mixed in such a manner that the mixture had a solid content mass ratio of silica to polyvinyl alcohol of 100:10, and the mixture was stirred. After that, the resultant was diluted and stirred so as to be a 5 mass % liquid.

(Production of Coating Liquid 4 for Silica Layer)

First, a dispersion liquid of spherical colloidal silica particles (Nissan Chemical Industries, Ltd., Snowtex ZL; average particle size of 75 nm through particle size measurement by laser scattering; solid content mass of 40 mass %), polyvinyl alcohol (JAPAN VAM & POVAL CO., LTD., JM-26) were prepared. Next, the dispersion liquid of spherical colloidal silica particles and an 8 mass % aqueous solution of polyvinyl alcohol were mixed in such a manner that the mixture had a solid content mass ratio of silica to polyvinyl alcohol of 100:10, and the mixture was stirred. After that, the resultant was diluted and stirred so as to be a 5 mass % liquid.

(Production of Coating Liquid 5 for Silica Layer)

First, a dispersion liquid of spherical colloidal silica particles (FUSO CHEMICAL CO., LTD., PL-20; average particle size of 340 nm through particle size measurement by laser scattering; solid content mass of 20 mass %), polyvinyl alcohol (JAPAN VAM & POVAL CO., LTD., JM-26) were prepared. Next, the dispersion liquid of spherical colloidal silica particles and an 8 mass % aqueous solution of polyvinyl alcohol were mixed in such a manner that the mixture had a solid content mass ratio of silica to polyvinyl alcohol of 100:10, and the mixture was stirred. After that, the resultant was diluted and stirred so as to be a 5 mass % liquid.

(Production of Coating Liquid 6 for Silica Layer)

First, a dispersion liquid of spherical colloidal silica particles (Nissan Chemical Industries, Ltd.; trade name Snowtex XL; average particle size of 50 nm through particle size measurement by laser scattering; solid content mass of 40 mass %), polyvinyl alcohol (JAPAN VAM & POVAL CO., LTD., JM-26) were prepared. Next, the dispersion liquid of spherical colloidal silica particles and an 8 mass % aqueous solution of polyvinyl alcohol were mixed in such a manner that the mixture had a solid content mass ratio of silica to polyvinyl alcohol of 100:10, and the mixture was stirred. After that, the resultant was diluted and stirred so as to be a 5 mass % liquid.

(Production of Coating Liquid 7 for Porous Layer)

Silica (TOKUYAMA Corp., trade name: REOLOSIL QS-09; BET specific surface area: about 90 m²/g) was mixed with ion exchanged water while stirring, whereby a silica crude dispersion liquid having a solid content of 20 mass % was obtained. Next, the silica crude dispersion liquid was subjected to dispersion treatment by a ball mill, whereby a silica crude dispersion liquid 7 was obtained. Note that a zirconia ball having a diameter of 0.1 mm was used as a grinding medium used in the ball mill. The average secondary particle size of silica particles contained in the obtained silica crude dispersion liquid 7 was measured by a laser scattering/diffraction particle size analyzer LS230 manufactured by Beckman Coulter Co., and was found to be 170 nm. The silica was a dry-process silica synthesized by a gas phase method. After that, a coating liquid 7 for a porous layer was obtained from the following composition.

| | |
|---|---|
| Component 1: silica crude dispersion liquid 1 | 100 parts by mass |
| Component 2: 8 mass % aqueous solution | 34 parts by mass |
| of polyvinyl alcohol (JAPAN VAM & POVAL | |
| CO., LTD., JM-26: saponification degree = | |
| about 97%) | |
| Component 3: crosslinking agent (3 mass % | 23 parts by mass |
| aqueous solution of boric acid) | |
| Component 4: self-crosslinking type cationic | 3 parts by mass |
| acrylic resin (DAICEL CHEMICAL INDUSTRIES, | |
| LTD., AQ-903, solid content of 26 mass %) | |

Pure water was added to a mixture of the components 1 to 4, followed by mixing and stirring, and the resultant was diluted in such a manner that the solid content thereof became 15 mass %, whereby the coating liquid 7 for a porous layer was obtained.

(Production of Coating Liquid 8 for Porous Layer)

Alumina hydrate powder (manufactured by Sasol Co., trade name: DISPERAL HP 14, specific surface area: 180 m²/g) was mixed with ion exchanged water while stirring, whereby an alumina hydrate crude dispersion liquid having a solid content of 20 mass % was obtained. Next, the alumina hydrate crude dispersion liquid was subjected to dispersion treatment by a homogenizer, whereby an alumina hydrate dispersion liquid was obtained. The average secondary particle size of alumina hydrate particles contained in the obtained alumina hydrate dispersion liquid was measured by a laser scattering/diffraction particle size analyzer LS230 manufactured by Beckman Coulter, and was found to be 170 nm.

20 parts by mass of a 10 mass % aqueous solution of polyvinyl alcohol (JAPAN VAM & POVAL CO., LTD., JM-26) was mixed and stirred with 100 parts by mass of the alumina hydrate dispersion liquid, and after that, the mixture was diluted with ion exchanged water, whereby a coating liquid 8 for a porous layer having a solid content of 15 mass % was obtained.

### Example 1

Resin coated paper (RC paper) for photograph printing having a basis weight of 120 g/m² was used as a substrate, and the substrate was coated with the coating liquid 7 by using a slot die coater in such a manner that the absolute dry amount of the coating liquid 7 became 20 g/m². After that, the coating liquid 7 was dried to thereby obtain an ink jet recording medium intermediate 1. Further, the ink jet recording medium intermediate 1 was coated with the coating liquid 1 by using the slot die coater in such a manner that the absolute dry amount became 100 mg/m², that is, in such a manner that the absolute dry amount of the spherical colloidal silica particles contained in the silica layer became 100 mg/m². After that, the coating liquid 1 was dried to thereby obtain an ink jet recording medium 1.

### Example 2

The ink jet recording medium intermediate 1 obtained in Example 1 was coated with the coating liquid 1 by using the slot die coater in such a manner that the absolute dry amount became 160 mg/m². After that, the coating liquid 1 was dried to thereby obtain an ink jet recording medium 2.

### Example 3

The ink jet recording medium intermediate 1 obtained in Example 1 was coated with the coating liquid 1 by using the slot die coater in such a manner that the absolute dry amount became 200 mg/m². After that, the coating liquid 1 was dried to thereby obtain an ink jet recording medium 3.

### Example 4

The ink jet recording medium intermediate 1 obtained in Example 1 was coated with the coating liquid 2 by using the slot die coater in such a manner that the absolute dry amount became 200 mg/m². After that, the coating liquid 2 was dried to thereby obtain an ink jet recording medium 4.

### Example 5

Resin coated paper (RC paper) for photograph printing having a basis weight of 120 g/m² was used as a substrate, and the substrate was coated with the coating liquid 8 by using the slot die coater in such a manner that the absolute dry amount of the coating liquid 8 became 25 g/m². After that, the coating liquid 8 was dried to thereby obtain an ink jet recording medium intermediate 2. Next, the ink jet recording medium intermediate 2 was coated with the coating liquid 1 by using the slot die coater in such a manner that the absolute dry amount became 160 mg/m². After that, the coating liquid 1 was dried to thereby obtain an ink jet recording medium 5.

### Comparative Example 1

The ink jet recording medium intermediate 1 obtained in Example 1 was coated with the coating liquid 1 by using the slot die coater in such a manner that the absolute dry amount of the coating liquid 1 became 75 mg/m After that, the coating liquid 1 was dried to thereby obtain an ink jet recording medium 6.

### Comparative Example 2

The ink jet recording medium intermediate 1 obtained in Example 1 was coated with the coating liquid 1 by using the slot die coater in such a manner that the absolute dry amount of the coating liquid 1 became 250 mg/m². After that, the coating liquid 1 was dried to thereby obtain an ink jet recording medium 7.

### Comparative Example 3

The ink jet recording medium intermediate 1 obtained in Example 1 was coated with the coating liquid 3 by using the slot die coater in such a manner that the absolute dry amount of the coating liquid 3 became 130 mg/m². After that, the coating liquid 3 was dried to thereby obtain an ink jet recording medium 8.

### Comparative Example 4

The ink jet recording medium intermediate 1 obtained in Example 1 was coated with the coating liquid 3 by using the slot die coater in such a manner that the absolute dry amount of the coating liquid 3 became 200 mg/m². After that, the coating liquid 3 was dried to thereby obtain an ink jet recording medium 9.

### Comparative Example 5

The ink jet recording medium intermediate 1 obtained in Example 1 was coated with the coating liquid 4 by using the slot die coater in such a manner that the absolute dry amount of the coating liquid 4 became 100 mg/m². After that, the coating liquid 4 was dried to thereby obtain an ink jet recording medium 10.

### Comparative Example 6

The ink jet recording medium intermediate 1 obtained in Example 1 was coated with the coating liquid 4 by using the slot die coater in such a manner that the absolute dry amount of the coating liquid 4 became 200 mg/m². After that, the coating liquid 4 was dried to thereby obtain an ink jet recording medium 11.

### Comparative Example 7

The ink jet recording medium intermediate 1 obtained in Example 1 was coated with the coating liquid 5 by using the slot die coater in such a manner that the absolute dry amount of the coating liquid 5 became 250 mg/m². After that, the coating liquid 5 was dried to thereby obtain an ink jet recording medium 12.

### Comparative Example 8

The ink jet recording medium intermediate 1 obtained in Example 1 was coated with the coating liquid 5 by using the slot die coater in such a manner that the absolute dry amount of the coating liquid 5 became 500 mg/m². After that, the coating liquid 5 was dried to thereby obtain an ink jet recording medium 13.

### Comparative Example 9

The ink jet recording medium intermediate 1 obtained in Example 1 was coated with the coating liquid 6 by using the slot die coater in such a manner that the absolute dry amount of the coating liquid 6 became 100 mg/m². After that, the coating liquid 6 was dried to thereby obtain an ink jet recording medium 14.

### Comparative Example 10

The ink jet recording medium intermediate 1 obtained in Example 1 was coated with the coating liquid 3 by using the slot die coater in such a manner that the absolute dry amount of the coating liquid 3 became 100 mg/m². After that, the coating liquid 3 was dried to thereby obtain an ink jet recording medium 15.

(Evaluation Method)

Regarding the ink jet recording media obtained in the above examples and comparative examples, glossiness, dye ink absorbency, pigment ink absorbency, haze, and coverage of the porous layer by the spherical colloidal silica particles were evaluated by the following methods.

(Glossiness)

20-degree glossiness was measured in accordance with JIS Z8741 by using a glossiness meter HG-268 manufactured by Suga Test Instruments Co., Ltd. The ink jet recording medium was evaluated as: “A” when the 20-degree glossiness thereof was 30 or more, which is sufficient as glossy paper; “B” when the 20-degree glossiness thereof was 20 or more and less than 30; or “C” when the 20-degree glossiness thereof was less than 20, which is insufficient as glossy paper.

(Dye Ink Absorbency)

A printer iPF500 manufactured by Canon Inc. was used to perform side-by-side printing of a solid image having 100% application amount of a dye black ink and a solid image having 100% application amount of a dye yellow ink, and then the boundary bleeding was visually observed. The ink jet recording medium was evaluated as: “A” when the boundary bleeding was not observed; “B” when the boundary bleeding was observed to some extent; or “C” when the boundary bleeding was observed to a large extent.

(Pigment Ink Absorbency, Haze)

A printer iPF5000 manufactured by Canon Inc. was used to perform printing of a solid image having 100% application amount of a pigment black ink and 100% application amount of a pigment gray ink to be 200% application amount in total, and then the image nonuniformity and haze (undertrapping) at a printed part depending on the pigment ink absorbency were visually observed. Regarding the pigment ink absorbency, the ink jet recording medium was evaluated as: “A” when the image was uniform; “B” when the image was almost uniform; or “C” when the image became nonuniform. Regarding the haze at a printed part, the ink jet recording medium was evaluated as: “A” when the undertrapping was not observed; “B” when the undertrapping was observed to some extent; or “C” when the undertrapping was observed to a large extent.

(Coverage)

The surface of the ink jet recording medium was photographed at 50,000-fold magnification with an electron microscope, and the coverage of the porous layer by the spherical colloidal silica particles was quantified in terms of percent by image processing.

The results thereof are shown below.

TABLE 1

| | | Particle | | Absolute dry | | | | | |
|---|---|---|---|---|---|---|---|---|---|
| | Recording | size of | Coverage | amount of | Glossiness | | | | Printed |
| | medium | silica | by silica | silica | 20-degree | | Dye ink | Pigment ink | part |
| | No. | particle | particles | particles | glossiness | Evaluation | Absorbency | Absorbency | Haze |
| Example 1 | 1 | 120 nm | 48% | 100 mg/m² | 25 | B | A | A | B |
| Example 2 | 2 | 120 nm | 60% | 160 mg/m² | 30 | A | A | B | B |
| Example 3 | 3 | 120 nm | 70% | 200 mg/m² | 33 | A | A | B | B |
| Example 4 | 4 | 200 nm | 45% | 200 mg/m² | 30 | A | A | A | B |
| Example 5 | 5 | 120 nm | 60% | 25 mg/m² | 31 | A | A | B | B |
| Comparative Example 1 | 6 | 120 nm | 20% | 75 mg/m² | 18 | C | A | A | B |
| Comparative Example 2 | 7 | 120 nm | 95% | 250 mg/m² | 38 | A | B | C | B |
| Comparative Example 3 | 8 | 100 nm | 90% | 130 mg/m² | 19 | C | A | C | B |
| Comparative Example 4 | 9 | 100 nm | 95% | 200 mg/m² | 35 | A | B | C | B |
| Comparative Example 5 | 10 | 75 nm | 72% | 100 mg/m² | 18 | C | A | C | B |
| Comparative Example 6 | 11 | 75 nm | 100% | 200 mg/m² | 40 | A | B | C | B |
| Comparative Example 7 | 12 | 340 nm | 45% | 250 mg/m² | 34 | A | A | A | C |
| Comparative Example 8 | 13 | 340 nm | 90% | 500 mg/m² | 40 | A | A | B | C |
| Comparative Example 9 | 14 | 50 nm | 100% | 100 mg/m² | 20 | B | C | C | A |
| Comparative Example 10 | 15 | 100 nm | 52% | 100 mg/m² | 15 | C | B | B | B |

From the results shown in Table 1, it is found that good results can be obtained when the spherical colloidal silica particles having a particle size of 105 nm or more and 200 nm or less are contained in the silica layer and the porous layer is covered by the spherical colloidal silica particles at a coverage of 40% or more and 75% or less. That is, it is found that there can be obtained good results that all of glossiness, dye ink absorbency, pigment ink absorbency, and haze at a printed part are each evaluated as “A” or “B”.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-165696, filed Jun. 25, 2008, which is hereby incorporated by reference herein in its entirety.

What is claimed is:

1. An ink jet recording medium, comprising:
a substrate;
a porous layer containing one of a dry-process silica and an alumina hydrate; and
a silica layer containing spherical colloidal silica particles having a particle size of 105 nm or more and 200 nm or less,
the porous layer and the silica layer being formed on the substrate in the stated order,
wherein the porous layer is covered by the spherical colloidal silica particles at a coverage of 40% or more and 75% or less.

2. An ink jet recording medium according to claim 1, wherein the spherical colloidal silica particles contained in the silica layer has an absolute dry amount of 100 mg/m² or more and 200 mg/m² or less.
